(19) United States
(12) Patent Application Publication
(10) Pub. No.: US 2009/0200807 A1
(43) Pub. Date: Aug. 13, 2009

(54) Adams alternative energy system

(76) Inventor: Wil Adams, Murrayville, GA (US)

Correspondence Address: Wil Ray Adams, 5439 Mount Vernon Rd., Murrayville, GA, 30564, US

(21) Appl. No.: 12/069,160

(22) Filed: Feb. 8, 2008

(51) Int. Cl. F03B 13/06; F03D 9/00

(52) U.S. Cl. 290/54; 290/55

(57) ABSTRACT

A system that may turn electricity generating devices with no emissions. The device is comprised of three major portions. The main intake portion, the collection tank portion with water pump, and the air exhaust portion. All of which require each portion to operate. The main intake portion may be several in number. The collection tank portion with water pump may be of any size required for the environment with which the system is operating in. The water pump to be placed in the collection tank portion may be of any size reasonable for the operation of the system. The air exhaust portion may be several in number.

### FIELD OF THE INVENTION

The present invention relates to alternative energy systems and, more particularly, to alternative energy systems that turn electricity generating devices

### BACKGROUND OF THE INVENTION

Most modern ways of generating electricity create pollution that is released back into the environment. Coal plants burn coal and release greenhouse gases into the atmosphere. Nuclear power plants create nuclear waste that is very hard to dispose of. Massive hydroelectric dams produce emissions free electricity but they are costly to build and can destroy natural habitats. Solar power needs sunlight to function. Wind power needs blowing wind to function. The Adams alternative energy system does not consume fuel so no emissions are produced. The system may be used to bring many alternative energy sources together. This device solves the problem of generating electricity without producing emissions. The device itself does not produce electricity but when an electricity generating device is attached to the system, electricity can be generated forever with no emissions or waste of any kind when water is flowing through the system. The Adams alternative energy system could help solve the problem of cheap emissions free electricity for developing countries who can not afford a nuclear power plant or a hydroelectric dam. The system is intended to be placed under water in lakes, seas, or the ocean. By being placed under water these systems can be built to enormous sizes without taking up space on land.

wind generated electricity

solar generated electricity

Wind turbines do not generate electricity if the wind is not blowing.

Solar panels do not generate electricity if the sun is not shining.

Nuclear power plants generate nuclear waste.

Hydroelectric dams destroy habitats and are costly to build.

It is another object of the invention to turn an electric generator with no emissions,

It is another object of the invention to provide cheap electricity to all countries.

It is another object of the invention to minimize impact on the environment by being placed under water.

It is another object of the invention to not produce nuclear waste.

### SUMMARY OF THE INVENTION

In accordance with the present invention, there is provided a system that may turn electricity generating devices with no emissions. The system is comprised of three major portions. The main intake portion, the collection tank portion with water pump, and the air exhaust portion. All of which require each portion to operate. The main intake portion may be several in number. The collection tank portion with water pump may be of any size required for the environment with which the system is operating in. The water pump to be placed in the collection tank portion may be of any size reasonable for the operation of the system. The air exhaust portion may be several in number.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an adams alternative energy system;

FIG. 2 is a front view of a main intake portion;

FIG. 3 is a front view of a collection tank portion with water pump; and

FIG. 4 is a front view of an air exhaust portion.

For purposes of clarity and brevity, like elements and components will bear the same designations and numbering throughout the Figures.

### DESCRIPTION OF THE PREFERRED EMBODIMENT

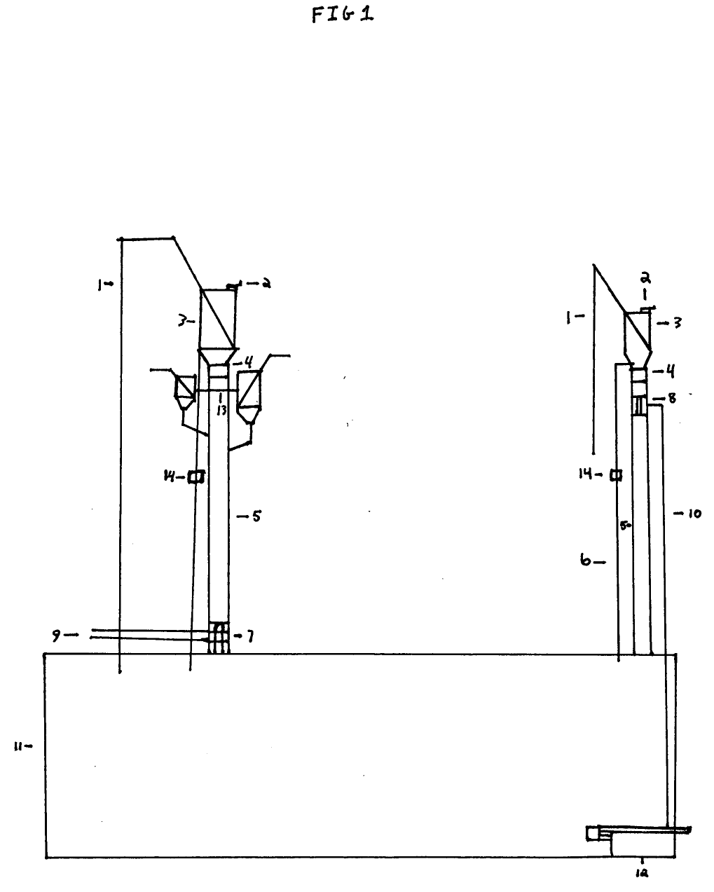

FIG. 1 is a perspective view of an Adams alternative energy system. In figure, 1 the system is comprised of three, major portions that may be attached by any means necessary for proper operation of the system. Elements 5 must be attached to element 11 securely. Elements 14 must enter the top of element 11 and not extend to the bottom of element 11 in order to operate properly. It is more ideal that elements 14 enter element 11 near elements 5. Element 10 may enter element 11 at any point sufficiently allowing element 10 to reach and be attached to element 12. Element 10 may be attached to element 11 by any means necessary for proper operation of the entire system.

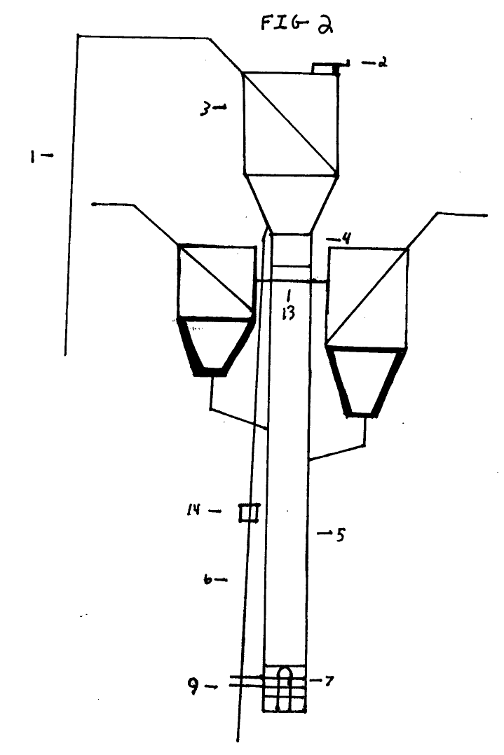

FIG. 2 is a front view of a main intake portion. Element 1 is intended to be attached to element 3. Element 1 must be at an angle and touch the inside surface of element 3 to function properly. Element 1 must be capable of bending and touching the surface of any body of water. Water must be able to flow freely up and into element 3. Optionally, holes may be bored into the upper side of element 1 above the surface of the water to allow air to be collected. Element 2 must be used to start the process of water siphoning. This process is started by closing element 14 and pouring water through element 2 and allowing water to build up in element 3. Element 2 must be closed and element 14 opened before the system can begin operating. Water must be allowed to collect in element 3 and flow freely through element 4. Element 4 must be attached to element 3, and point downward so water can flow freely into element 11. Element 5 must be attached to element 6. Element 5 must point downward and allow water to flow freely to element 7. Element 6 must support the type 1 siphon device above any water surface and attach the type 1 siphon device with element 5. Element 7 may be any water turbine 7 device that generates sufficient electrical requirements for the entire system or outbound needs. Element 9 must be electrical wiring that will be capable to meet the needs of the entire system. Elements 13 must attach the type 2 siphon devices to element 5 below the water line. Elements 13 should not penetrate the type 2 siphon devices. The type 2 siphon devices may be configured in the same manner as type 1 siphon devices with the exception that type 2 siphon devices must be placed under water and element 1 should be shortened. Elements 4 should enter element 5 and allow water to flow freely into element 5. Element 14 may be attached to any point on elements 4 in order to stop the flow of water. All amounts of water to be used in operating the main intake portion are to be assessed by the operators of the system. All elements of the main intake portion may be comprised of any material deemed necessary for the operation of the system.

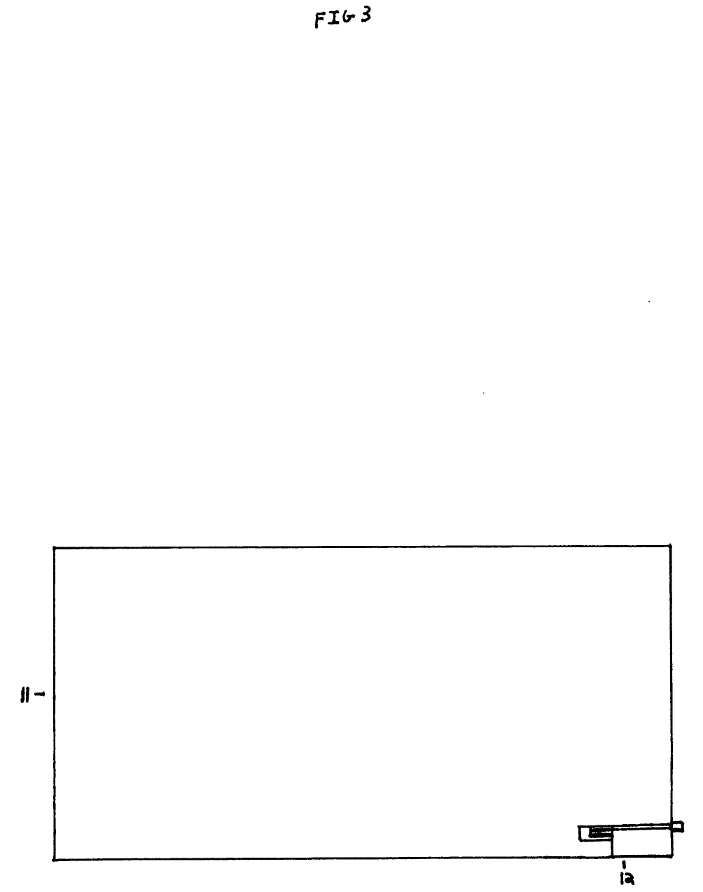

FIG. 3 is a front view of a collection tank portion with water pump 12. Element 11 should be placed under the water at a depth necessary for the system to operate. Element 12 may be several in number. Element 12 may be attached to element 11 by any way appropriate for proper functioning of the system. Element 12 may be placed anywhere inside or outside element 11 deemed reasonable for proper system operation. All elements of the collection tank portion with water pump 12 may be comprised of any material necessary for proper operation of the system.

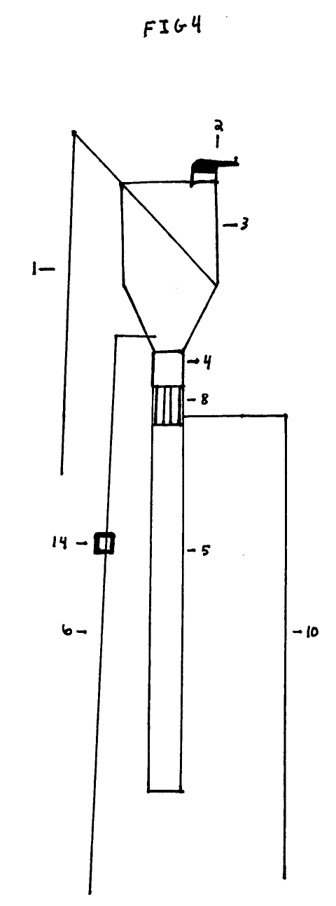

FIG. 4 is a front view of an air exhaust portion. Element 1 is intended to be attached to element 3. Element 1 must be at an angle and touch the inside surface of element 3. It is crucial that element 1 have intake holes so water and air may travel into element 3. The end of element 1 outside element 3 must be placed on or under the surface of the water. Element 2 must be used to start the process of water siphoning. This process is the same as the type 1 siphon device in FIG. 2. Element 4 must be attached to the bottom of element 3. Element 4 must allow water to freely flow downward into the collection tank in FIG. 3. Element 5 must be attached to element 6 which is attached to element 3. Element 5 must have sufficient height and width for proper operation of the system. Element 5 must allow air to travel freely up and into the atmosphere. Element 6 must be attached to element 5 and element 3. Element 6 should be strong enough to keep the type 1 siphon device well above the surface of the water. Element 8 may be any wind powered turbine sufficient for the systems operation. Element 10 may be any wiring capable of delivering electricity to an electric pump or out of system requirements. Element 14 may be placed anywhere along element 4 in order to stop the flow of water for a period long enough for the siphon process to begin. All elements in FIG. 4 may be comprised of any materials deemed necessary for the functioning of the system.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An adams alternative energy system for an adams alternative energy system for turning electricity generating devices, comprising:
means for intake water;
means for hold intake water, safely connected to said means for intake water;
means for allowing water in to start the syphon pump, safely connected to said means for hold intake water;
means for releasing water exhaust, safely connected to said means for hold intake water;
means for to channel exhaust water and hold generating devices, safely connected to said means for hold intake water;
means for to support the syphon pump, safely connected to said means for hold intake water;
means for to generate electricity, safely connected to said means for to channel exhaust water and hold generating devices;
means for to generate electricity, safely connected to said means for to channel exhaust water and hold generating devices;
means for to transfer electricity to homes, safely connected to said means for to generate electricity;
means for to transfer electricity to homes, safely connected to said means for to generate electricity;
means for to hold exhaust water, safely connected to said means for to channel exhaust water and hold generating devices;
means for to pump water out of the water exhaust tank, safely connected to said means for to hold exhaust water;
means for to support the intake containers, safely connected to said means for hold intake water; and
means for to prevent premature syphon pump operation.

2. The adams alternative energy system in accordance with claim 1, wherein said means for intake water comprises an intake hose.

3. The adams alternative energy system in accordance with claim 1, wherein said means for hold intake water comprises an intake container.

4. The adams alternative energy system in accordance with claim 1, wherein said means for allowing water in to start the syphon pump comprises a water allowance tube.

5. The adams alternative energy system in accordance with claim 1, wherein said means for releasing water exhaust comprises a water exhaust hose.

6. The adams alternative energy system in accordance with claim 1, wherein said means for to channel exhaust water and hold generating devices comprises a water gravity pipe.

7. The adams alternative energy system in accordance with claim 1, wherein said means for to support the syphon pump comprises a syphon pump support.

8. The adams alternative energy system in accordance with claim 1, wherein said means for to generate electricity comprises a water turbine.

9. The adams alternative energy system in accordance with claim 1, where in said means for to generate electricity comprises a wind turbine.

10. The adams alternative energy system in accordance with claim 1, wherein said means for to transfer electricity to homes comprises a water turbine wiring.

11. The adams alternative energy system in accordance with claim 1, wherein said means for to transfer electricity to homes comprises a wind turbine wiring.

12. The adams alternative energy system in accordance with claim 1, wherein said means for to hold exhaust water comprises a water exhaust holding tank.

13. The adams alternative energy system in accordance with claim 1, wherein said means for to pump water out of the water exhaust tank comprises a water pump.

14. The adams alternative energy system in accordance with claim 1, wherein said means for to support the intake containers comprises an intake container support.

15. The adams alternative energy system in accordance with claim 1, wherein said means for to prevent premature syphon pump operation comprises a water exhaust hose valve.
